(19) United States
(12) Patent Application Publication
(10) Pub. No.: US 2010/0033121 A1
(43) Pub. Date: Feb. 11, 2010

(54) Blind security

(76) Inventor: Alvin Dill, Centerville, MD (US)

Correspondence Address: RUTH EURE, 4795 EDISON AVENUE, BOULDER, CO, 80301, US

(21) Appl. No.: 12/387,167

(22) Filed: Apr. 29, 2009

Related U.S. Application Data
(60) Provisional application No. 61/125,882, filed on Apr. 29, 2008.

(51) Int. Cl. H02P 1/00

(52) U.S. Cl. 318/484

(57) ABSTRACT

The blind arrangement can be controlled by means of a preprogrammed control device and is powered by a power supply such as for instance a battery. According to the invention, the blind arrangement comprises a timing device, an operating member for opening and closing the blinds and a motor for driving the operating member wherein the operating member is activated at predetermined times to open and close the blinds and a power supply for driving the motor.

### CLAIM OF PRIORITY

This patent application claims priority from U.S. Provisional patent application Ser. No. 61/125,882, filed Apr. 29, 2008, entitled “Blind Security” of common inventorship herewith.

### FIELD OF THE INVENTION

The present invention pertains to the field of window blind opening and closing devices.

### BACKGROUND OF THE INVENTION

The prior art has put forth several designs for devices which open and close window blinds.

U.S. Pat. No. 5,909,093 to Van Dinteren et al describes a automatically controlled blind arrangement.

U.S. Pat. No. 6,259,218 to Kovach et al describes a battery powered wireless remote control motorized window covering assembly having a microprocessor controller.

U.S. Pat. No. 6,850,017 to Domel et al describes a head rail mounted actuator for window coverings.

None of these prior art devices describe or suggest the present invention.

### SUMMARY OF THE INVENTION

It is an object of the present invention to provide a timed, electrically powered device for automatically opening and closing a set of window blinds.

### BRIEF DESCRIPTION OF THE DRAWINGS

FIG. 1 shows a window equipped with blinds having the present invention for blind opening and closing mounted on the wall near the window.

FIG. 2 shows a close up of the controller unit of the present invention showing the timing device and battery area.

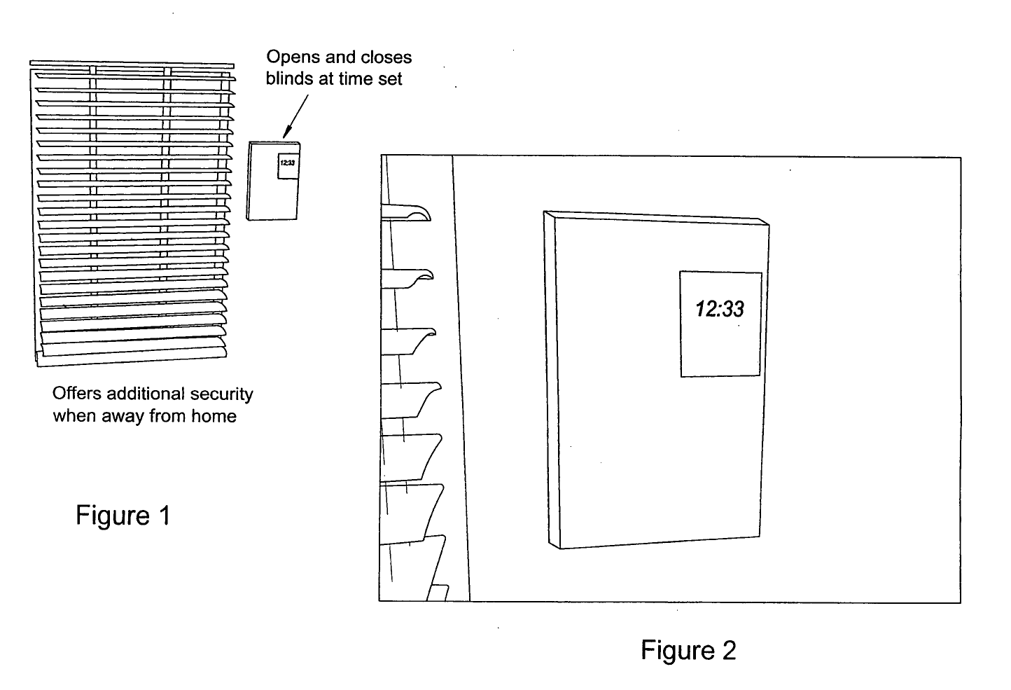

### DETAILED DESCRIPTION OF THE INVENTION

The word “window” comes to us from the Scandinavians who invaded and settled in England in the early Middle Ages. A compound made up of vindr, for “wind,” and auga, for “eye,” the Norse “wind-eye” became the English “window”—reflecting the fact that, for most of human history, windows contained no glass. They did let in light and allowed their owners a view of the world outside, but for hundreds of years windows were simply openings in walls-eyes through which the wind blew. Today we speak of windows with words less poetic than “wind-eye,” but in each case, the “window” is seen as an opening, a portal through which something passes, as light passes through clear glass. A cable news network claims to be our “window on the world.” We check our calendars to see whether we have a “window of opportunity” to do something on a given day. Lovers claim that the eyes of their beloved are “windows on the soul.” We open and close the “windows” on our computer screens, gaining views of work, play, and information. NASA officials postpone rocket launches until decent weather arrives—seeking a “launch window” that will allow a given trajectory. When some possibility for us vanishes, we might dismiss it as “out the window.” Each of these expressions, we understand, is a metaphor, not a window—but the fact that we have so many window metaphors does suggest the importance of windows in our lives.

Glass windows let in the light of the world, affording us a view while protecting us from extremes of temperature and humidity. As essential as they are to our home and work life, however, there are two basic problems with windows. One is that, uncovered, they can let in too much light; and the second is that, uncovered, when we're not looking out, other people might be looking in. Add the loss or gain of heat, and it becomes clear why curtains or blinds—which block light, and can be opened or closed by degrees—came into being. In many homes and offices today, Venetian blinds or a variation of these, vertical blinds, have taken the place of curtains. Blinds have the advantage of greater variability than curtains, since the individual louvers can be finely adjusted to let in or block outside light, while the blinds themselves stay in place—but contemporary vertical blinds have a rather serious disadvantage as well. If we have to be away from home on a business or vacation trip, we must either leave the blinds open, inviting would-be burglars to get a view of our possessions; or leave them closed, which may likewise suggest to a burglar that the dwelling is unoccupied. The invention to be described in this report is intended to correct this problem.

Recognizing that homeowners need a variety of ways to make their dwellings appear occupied even when they are not, the present invention was developed and is hereinafter referred to as “Blind Security.” Simply stated, the Blind Security would be an electrically powered, fully automated, timed system for opening and closing—at pre-set or random hours—the window blinds of an unoccupied house. Manufactured by the Window Hardware, Drapery, Blinds and Shades industry, Standard Industrial Code 2591, the Blind Security would consist of several components: 1) an electrical-supply component, which could be battery power, 110-volt household alternating current, or household current with a battery back-up, to operate: 2) a small electric rotary motor, which would: 3) turn on and off according to a timer, this timer being set to open and close the blinds at regular times (or at random), by means of: 4) the blind's control-wand, to which the rotary motor would be linked. As to the timing device, this could be pre-set by the homeowner, as noted; or it could be activated by a photo-electric “eye” or light-sensor that would sense twilight, then close the blinds, and sense dawn, then open the blinds. In each case, once the Blind Security system were in place, the timer would determine the opening and closing of the blinds, and do so at any time interval the homeowner chose. With the feature of household current backed up by emergency battery-power, the Blind Security system would operate even in the event of a power outage.

The Blind Security, an automated system for opening and closing window blinds according to a pre-set timer, presents a number of distinct and significant benefits and advantages. Foremost is the added security that a homeowner would experience in knowing that his or her house would appear occupied, even when they were away on business or vacation. In many cases, homeowners use timed devices to turn lights on and off, and this has been found to be effective. But adding the element of opening and closing blinds increases the appearance and impression that someone is in the house, and this impression is essential in dissuading burglars from breaking in. The Blind Security system could be pre-set, with the blinds in one room closing at one hour, the blinds in another room closing at a different time; the system can be set to open or close the blinds at different times on different days; and the system can be set to open and close the blinds on a random schedule: in each case, the appearance of an occupied house is strengthened, and any burglar casing the place would conclude that the homeowners were home. Thus, combining the Blind Security device with a timed lighting device is desirable, as these appearance-effects reinforce one another. The Blind Security system also operates even when the power supply was interrupted, in times of power outage—this is particularly important, since power outages and blackouts are often times of lawlessness and looting. Affordable, effective, and easily installed with a minimum of tools, the Blind Security provides a heightened level of security for homeowners, costing relatively little for a big payoff in both security and peace of mind.

A timed, electrically powered device for automatically opening and closing a set of window blinds, the Blind Security system opens and closes window blinds at pre-set times, discouraging burglary even when the dwelling was vacant.

The timers, motor controls and operating mechanisms useful for use in the present invention are commonly known in the art and a person of ordinary skill in the art will be able to construct the present invention using commercially available components.

The invention underlying the present disclosure relates to a manually or automatically controlled blind arrangement comprising an operating member for operating the blind arrangement, a motor for driving the operating member and a timer system, wherein the operating member opens and closes the blinds at predetermined times.

Such a manually or automatically controlled blind arrangement may be a slatted arrangement or a shade arrangement, and can be used in home and office applications.

The invention has as an object to provide a manually or automatically controlled blind arrangement, which arranges for reduced power consumption. It is a further object of the present invention to provide an automatically controlled blind arrangement which can be manufactured from relatively cheap components.

An automatically controlled blind arrangement in accordance with the present invention may be provided with manual operation equipment, such as a manual tilt or lift control.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A blind opening and closing device comprising:
a timing device for actuating the device at predetermined time intervals;
an operating member for mechanically opening and closing the blinds; wherein the operating member opens and closes the blinds at predetermined times;
a motor for driving the operating member; and
a power supply for driving the motor.

2. The device of claim 1 wherein the power supply is a battery.

3. The device of claim 1 wherein the power supply is house current.
